(19) United States
(12) Patent Application Publication
(10) Pub. No.: US 2024/0248911 A1
(43) Pub. Date: Jul. 25, 2024

(54) Systems and Methods for Optimized Metro Clone Creation and Refresh of Metro Volumes

(71) Applicant: Dell Products L.P., Round Rock, TX (US)

(72) Inventors: Vasudevan Subramanian, Chapel Hill, NC (US); Girish Sheelvant, Hopkinton, MA (US); Dmitry Tylik, Westborough, MA (US)

(21) Appl. No.: 18/159,636

(22) Filed: Jan. 25, 2023

(51) Int. Cl. G06F 16/27

(52) U.S. Cl. CPC G06F 16/275

(57) ABSTRACT

A method, computer program product, and computer system for creating, by a computing device, a snapshot, wherein the snapshot may be a consistent byte for byte identical snapshot of a metro volume on a first site and a second site. A metro clone may be created from the snapshot of the metro volume on the first site and the second site. The metro clone may be mirrored. The metro clone and the metro volume may be refreshed on both the first site and the second site using an identical snapshot on both the first site and the second site.

### BACKGROUND

Generally, in a metro replication or synchronization (sync) replication, there are two data centers or sites (e.g., SiteA and SiteB) and the computing, networking, and storage resources on the two sites provide the needed redundancy for the user's application. Applications that need higher availability typically configure the volumes in use by the application for metro sync or sync replication.

### BRIEF SUMMARY OF DISCLOSURE

In one example implementation, a method, performed by one or more computing devices, may include but is not limited to creating, by a computing device, a snapshot, wherein the snapshot may be a consistent byte for byte identical snapshot of a metro volume on a first site and a second site. A metro clone may be created from the snapshot of the metro volume on the first site and the second site. The metro clone may be mirrored. The metro clone may be refreshed on both the first site and the second site.

One or more of the following example features may be included. Refreshing the metro clone on both the first site and the second site may include creating a second identical snapshot for a production volume on the first site and the second site. Refreshing the metro clone on both the first site and the second site may further include stopping an application using the metro clone. Refreshing the metro clone on both the first site and the second site may further include unmapping the metro clone from a host, wherein the metro clone may be unmapped from the host on both the first site and the second site. Refreshing the metro clone on both the first site and the second site may further include refreshing, synchronously from the second identical snapshot, the metro clone for the production volume on both the first site and the second site. The metro volume may be refreshed. Refreshing the metro volume may include creating a third identical snapshot for the metro clone on the first site and the second site, stopping an application using the metro volume, unmapping the metro volume from a host, wherein the metro volume may be unmapped from the host on both the first site and the second site, and refreshing, synchronously from the third identical snapshot, the metro volume on both the first site and the second site.

In another example implementation, a computing system may include one or more processors and one or more memories configured to perform operations that may include but are not limited to creating a snapshot, wherein the snapshot may be a consistent byte for byte identical snapshot of a metro volume on a first site and a second site. A metro clone may be created from the snapshot of the metro volume on the first site and the second site. The metro clone may be mirrored. The metro clone may be refreshed on both the first site and the second site.

One or more of the following example features may be included. Refreshing the metro clone on both the first site and the second site may include creating a second identical snapshot for a production volume on the first site and the second site. Refreshing the metro clone on both the first site and the second site may further include stopping an application using the metro clone. Refreshing the metro clone on both the first site and the second site may further include unmapping the metro clone from a host, wherein the metro clone may be unmapped from the host on both the first site and the second site. Refreshing the metro clone on both the first site and the second site may further include refreshing, synchronously from the second identical snapshot, the metro clone for the production volume on both the first site and the second site. The metro volume may be refreshed. Refreshing the metro volume may include creating a third identical snapshot for the metro clone on the first site and the second site, stopping an application using the metro volume, unmapping the metro volume from a host, wherein the metro volume may be unmapped from the host on both the first site and the second site, and refreshing, synchronously from the third identical snapshot, the metro volume on both the first site and the second site.

In another example implementation, a computer program product may reside on a computer readable storage medium having a plurality of instructions stored thereon which, when executed across one or more processors, may cause at least a portion of the one or more processors to perform operations that may include but are not limited to creating a snapshot, wherein the snapshot may be a consistent byte for byte identical snapshot of a metro volume on a first site and a second site. A metro clone may be created from the snapshot of the metro volume on the first site and the second site. The metro clone may be mirrored. The metro clone may be refreshed on both the first site and the second site.

One or more of the following example features may be included. Refreshing the metro clone on both the first site and the second site may include creating a second identical snapshot for a production volume on the first site and the second site. Refreshing the metro clone on both the first site and the second site may further include stopping an application using the metro clone. Refreshing the metro clone on both the first site and the second site may further include unmapping the metro clone from a host, wherein the metro clone may be unmapped from the host on both the first site and the second site. Refreshing the metro clone on both the first site and the second site may further include refreshing, synchronously from the second identical snapshot, the metro clone for the production volume on both the first site and the second site. The metro volume may be refreshed. Refreshing the metro volume may include creating a third identical snapshot for the metro clone on the first site and the second site, stopping an application using the metro volume, unmapping the metro volume from a host, wherein the metro volume may be unmapped from the host on both the first site and the second site, and refreshing, synchronously from the third identical snapshot, the metro volume on both the first site and the second site.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a optimization process coupled to an example distributed computing network according to one or more example implementations of the disclosure;

FIG. 2 is an example diagrammatic view of a storage system of FIG. 1 according to one or more example implementations of the disclosure;

FIG. 3 is an example diagrammatic view of a storage target of FIG. 1 according to one or more example implementations of the disclosure; and

FIG. 4 is an example flowchart of a optimization process according to one or more example implementations of the disclosure.

Like reference symbols in the various drawings indicate like elements.

### DETAILED DESCRIPTION

### System Overview:

In some implementations, the present disclosure may be embodied as a method, system, or computer program product. Accordingly, in some implementations, the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, in some implementations, the present disclosure may take the form of a computer program product on a computer-usable storage medium having computer-usable program code embodied in the medium.

In some implementations, any suitable computer usable or computer readable medium (or media) may be utilized. The computer readable medium may be a computer readable signal medium or a computer readable storage medium. The computer-usable, or computer-readable, storage medium (including a storage device associated with a computing device or client electronic device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a digital versatile disk (DVD), a static random access memory (SRAM), a memory stick, a floppy disk, a mechanically encoded device such as punch-cards or raised structures in a groove having instructions recorded thereon, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of the present disclosure, a computer-usable or computer-readable, storage medium may be any tangible medium that can contain or store a program for use by or in connection with the instruction execution system, apparatus, or device.

In some implementations, a computer readable signal medium may include a propagated data signal with computer readable program code embodied therein, for example, in baseband or as part of a carrier wave. In some implementations, such a propagated signal may take any of a variety of forms, including, but not limited to, electro-magnetic, optical, or any suitable combination thereof. In some implementations, the computer readable program code may be transmitted using any appropriate medium, including but not limited to the internet, wireline, optical fiber cable, RF, etc. In some implementations, a computer readable signal medium may be any computer readable medium that is not a computer readable storage medium and that can communicate, propagate, or transport a program for use by or in connection with an instruction execution system, apparatus, or device.

In some implementations, computer program code for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java®, Smalltalk, C++ or the like. Java® and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as Javascript, PERL, or Python. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the internet using an Internet Service Provider). In some implementations, electronic circuitry including, for example, programmable logic circuitry, field-programmable gate arrays (FPGAs) or other hardware accelerators, micro-controller units (MCUs), or programmable logic arrays (PLAs) may execute the computer readable program instructions/code by utilizing state information of the computer readable program instructions to personalize the electronic circuitry, in order to perform aspects of the present disclosure.

In some implementations, the flowchart and block diagrams in the figures illustrate the architecture, functionality, and operation of possible implementations of apparatus (systems), methods and computer program products according to various implementations of the present disclosure. Each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of the order noted in the figures (or combined or omitted). For example, two blocks shown in succession may, in fact, be executed substantially concurrently, or the blocks may sometimes be executed in the reverse order, depending upon the functionality involved.

In some implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

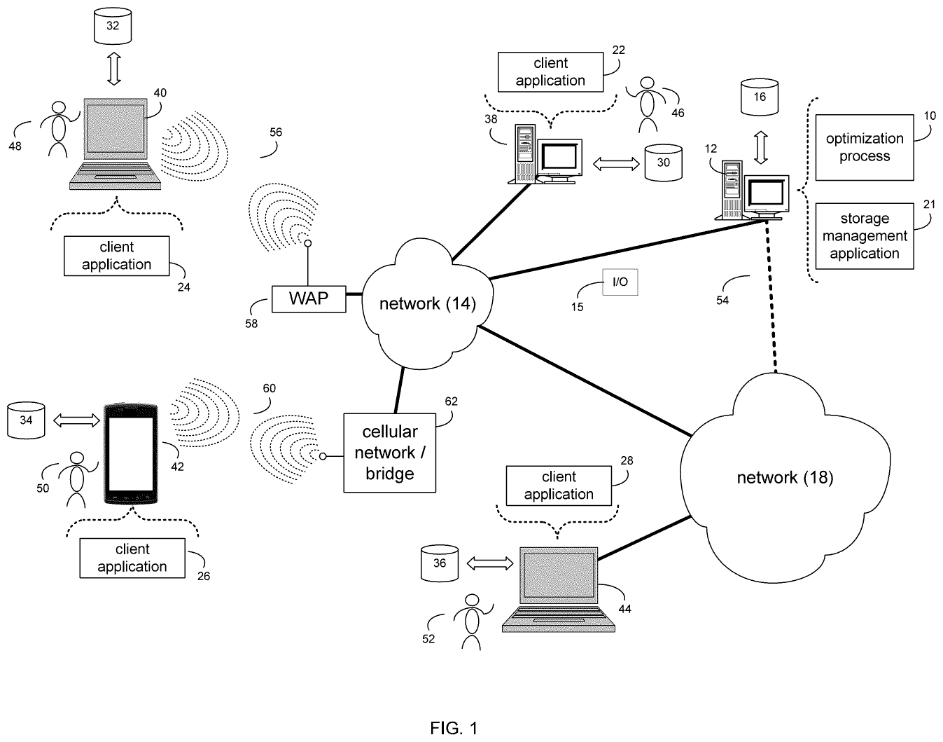

Referring now to the example implementation of FIG. 1, there is shown optimization process 10 that may reside on and may be executed by a computer (e.g., computer 12), which may be connected to a network (e.g., network 14) (e.g., the internet or a local area network). Examples of computer 12 (and/or one or more of the client electronic devices noted below) may include, but are not limited to, a storage system (e.g., a Network Attached Storage (NAS) system, a Storage Area Network (SAN)), a personal computer(s), a laptop computer(s), mobile computing device(s), a server computer, a series of server computers, a mainframe computer(s), or a computing cloud(s). As is known in the art, a SAN may include one or more of the client electronic devices, including a Redundant Array of Inexpensive Disks/Redundant Array of Independent Disks (RAID) device and a NAS system. In some implementations, each of the aforementioned may be generally described as a computing device. In certain implementations, a computing device may be a physical or virtual device. In many implementations, a computing device may be any device capable of performing operations, such as a dedicated processor, a portion of a processor, a virtual processor, a portion of a virtual processor, portion of a virtual device, or a virtual device. In some implementations, a processor may be a physical processor or a virtual processor. In some implementations, a virtual processor may correspond to one or more parts of one or more physical processors. In some implementations, the instructions/logic may be distributed and executed across one or more processors, virtual or physical, to execute the instructions/logic. Computer 12 may execute an operating system, for example, but not limited to, Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, a optimization process, such as optimization process 10 of FIG. 1, may create, by a computing device, a snapshot, wherein the snapshot may be a consistent byte for byte identical snapshot of a metro volume on a first site and a second site. A metro clone may be created from the snapshot of the metro volume on the first site and the second site. The metro clone may be mirrored. The metro clone may be refreshed on both the first site and the second site.

In some implementations, the instruction sets and subroutines of optimization process 10, which may be stored on storage device, such as storage device 16, coupled to computer 12, may be executed by one or more processors and one or more memory architectures included within computer 12. In some implementations, storage device 16 may include but is not limited to: a hard disk drive; all forms of flash memory storage devices; a tape drive; an optical drive; a RAID array (or other array); a random access memory (RAM); a read-only memory (ROM); or combination thereof. In some implementations, storage device 16 may be organized as an extent, an extent pool, a RAID extent (e.g., an example 4D+1P R5, where the RAID extent may include, e.g., five storage device extents that may be allocated from, e.g., five different storage devices), a mapped RAID (e.g., a collection of RAID extents), or combination thereof.

In some implementations, network 14 may be connected to one or more secondary networks (e.g., network 18), examples of which may include but are not limited to: a local area network; a wide area network or other telecommunications network facility; or an intranet, for example. The phrase “telecommunications network facility,” as used herein, may refer to a facility configured to transmit, and/or receive transmissions to/from one or more mobile client electronic devices (e.g., cellphones, etc.) as well as many others.

In some implementations, computer 12 may include a data store, such as a database (e.g., relational database, object-oriented database, triplestore database, etc.) and may be located within any suitable memory location, such as storage device 16 coupled to computer 12. In some implementations, data, metadata, information, etc. described throughout the present disclosure may be stored in the data store. In some implementations, computer 12 may utilize any known database management system such as, but not limited to, DB2, in order to provide multi-user access to one or more databases, such as the above noted relational database. In some implementations, the data store may also be a custom database, such as, for example, a flat file database or an XML database. In some implementations, any other form(s) of a data storage structure and/or organization may also be used. In some implementations, optimization process 10 may be a component of the data store, a standalone application that interfaces with the above noted data store and/or an applet/application that is accessed via client applications 22, 24, 26, 28. In some implementations, the above noted data store may be, in whole or in part, distributed in a cloud computing topology. In this way, computer 12 and storage device 16 may refer to multiple devices, which may also be distributed throughout the network.

In some implementations, computer 12 may execute a storage management application (e.g., storage management application 21), examples of which may include, but are not limited to, e.g., a storage system application, a cloud computing application, a data synchronization application, a data migration application, a garbage collection application, or other application that allows for the implementation and/or management of data in a clustered (or non-clustered) environment (or the like). In some implementations, optimization process 10 and/or storage management application 21 may be accessed via one or more of client applications 22, 24, 26, 28. In some implementations, optimization process 10 may be a standalone application, or may be an applet/application/script/extension that may interact with and/or be executed within storage management application 21, a component of storage management application 21, and/or one or more of client applications 22, 24, 26, 28. In some implementations, storage management application 21 may be a standalone application, or may be an applet/application/script/extension that may interact with and/or be executed within optimization process 10, a component of optimization process 10, and/or one or more of client applications 22, 24, 26, 28. In some implementations, one or more of client applications 22, 24, 26, 28 may be a standalone application, or may be an applet/application/script/extension that may interact with and/or be executed within and/or be a component of optimization process 10 and/or storage management application 21. Examples of client applications 22, 24, 26, 28 may include, but are not limited to, e.g., a storage system application, a cloud computing application, a data synchronization application, a data migration application, a garbage collection application, or other application that allows for the implementation and/or management of data in a clustered (or non-clustered) environment (or the like), a standard and/or mobile web browser, an email application (e.g., an email client application), a textual and/or a graphical user interface, a customized web browser, a plugin, an Application Programming Interface (API), or a custom application. The instruction sets and subroutines of client applications 22, 24, 26, 28, which may be stored on storage devices 30, 32, 34, 36, coupled to client electronic devices 38, 40, 42, 44, may be executed by one or more processors and one or more memory architectures incorporated into client electronic devices 38, 40, 42, 44.

In some implementations, one or more of storage devices 30, 32, 34, 36, may include but are not limited to: hard disk drives; flash drives, tape drives; optical drives; RAID arrays; random access memories (RAM); and read-only memories (ROM). Examples of client electronic devices 38, 40, 42, 44 (and/or computer 12) may include, but are not limited to, a personal computer (e.g., client electronic device 38), a laptop computer (e.g., client electronic device 40), a smart/data-enabled, cellular phone (e.g., client electronic device 42), a notebook computer (e.g., client electronic device 44), a tablet, a server, a television, a smart television, a smart speaker, an Internet of Things (IoT) device, a media (e.g., video, photo, etc.) capturing device, and a dedicated network device. Client electronic devices 38, 40, 42, 44 may each execute an operating system, examples of which may include but are not limited to, Android™, Apple® iOS®, Mac® OS X®; Red Hat® Linux®, Windows® Mobile, Chrome OS, Blackberry OS, Fire OS, or a custom operating system.

In some implementations, one or more of client applications 22, 24, 26, 28 may be configured to effectuate some or all of the functionality of optimization process 10 (and vice versa). Accordingly, in some implementations, optimization process 10 may be a purely server-side application, a purely client-side application, or a hybrid server-side/client-side application that is cooperatively executed by one or more of client applications 22, 24, 26, 28 and/or optimization process 10.

In some implementations, one or more of client applications 22, 24, 26, 28 may be configured to effectuate some or all of the functionality of storage management application 21 (and vice versa). Accordingly, in some implementations, storage management application 21 may be a purely server-side application, a purely client-side application, or a hybrid server-side/client-side application that is cooperatively executed by one or more of client applications 22, 24, 26, 28 and/or storage management application 21. As one or more of client applications 22, 24, 26, 28, optimization process 10, and storage management application 21, taken singly or in any combination, may effectuate some or all of the same functionality, any description of effectuating such functionality via one or more of client applications 22, 24, 26, 28, optimization process 10, storage management application 21, or combination thereof, and any described interaction(s) between one or more of client applications 22, 24, 26, 28, optimization process 10, storage management application 21, or combination thereof to effectuate such functionality, should be taken as an example only and not to limit the scope of the disclosure.

In some implementations, one or more of users 46, 48, 50, 52 may access computer 12 and optimization process 10 (e.g., using one or more of client electronic devices 38, 40, 42, 44) directly through network 14 or through secondary network 18. Further, computer 12 may be connected to network 14 through secondary network 18, as illustrated with phantom link line 54. Optimization process 10 may include one or more user interfaces, such as browsers and textual or graphical user interfaces, through which users 46, 48, 50, 52 may access optimization process 10.

In some implementations, the various client electronic devices may be directly or indirectly coupled to network 14 (or network 18). For example, client electronic device 38 is shown directly coupled to network 14 via a hardwired network connection. Further, client electronic device 44 is shown directly coupled to network 18 via a hardwired network connection. Client electronic device 40 is shown wirelessly coupled to network 14 via wireless communication channel 56 established between client electronic device 40 and wireless access point (i.e., WAP) 58, which is shown directly coupled to network 14. WAP 58 may be, for example, an IEEE 802.11a, 802.11b, 802.11g, 802.11n, 802.11ac, Wi-Fi®, RFID, and/or Bluetooth™ (including Bluetooth™ Low Energy) device that is capable of establishing wireless communication channel 56 between client electronic device 40 and WAP 58. Client electronic device 42 is shown wirelessly coupled to network 14 via wireless communication channel 60 established between client electronic device 42 and cellular network/bridge 62, which is shown by example directly coupled to network 14.

In some implementations, some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth™ (including Bluetooth™ Low Energy) is a telecommunications industry specification that allows, e.g., mobile phones, computers, smart phones, and other electronic devices to be interconnected using a short-range wireless connection. Other forms of interconnection (e.g., Near Field Communication (NFC)) may also be used.

In some implementations, various I/O requests (e.g., I/O request 15) may be sent from, e.g., client applications 22, 24, 26, 28 to, e.g., computer 12. Examples of I/O request 15 may include but are not limited to, data write requests (e.g., a request that content be written to computer 12) and data read requests (e.g., a request that content be read from computer 12).

### Data Storage System:

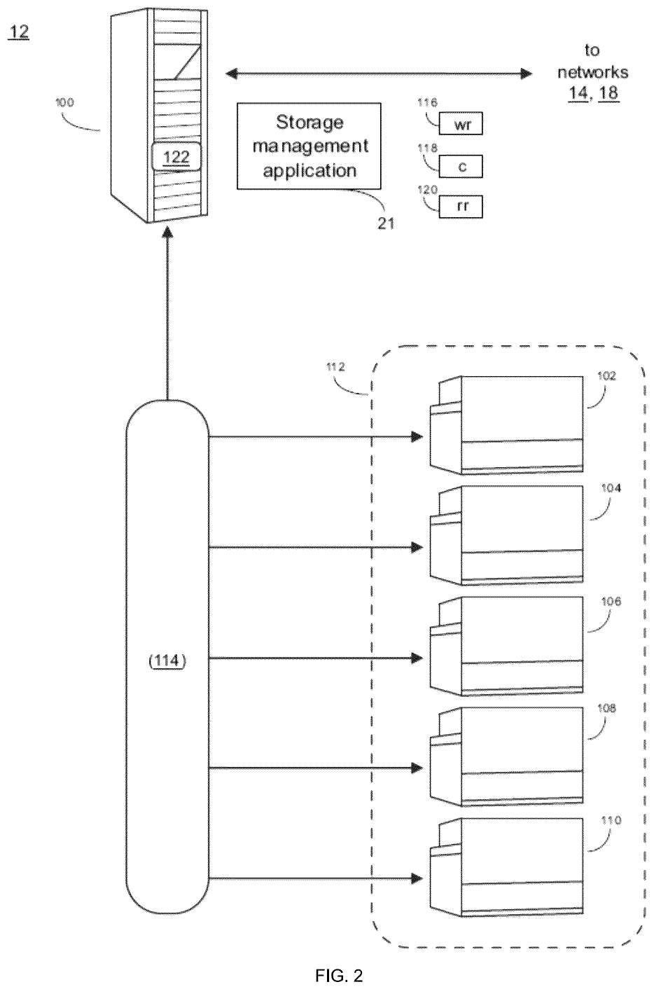

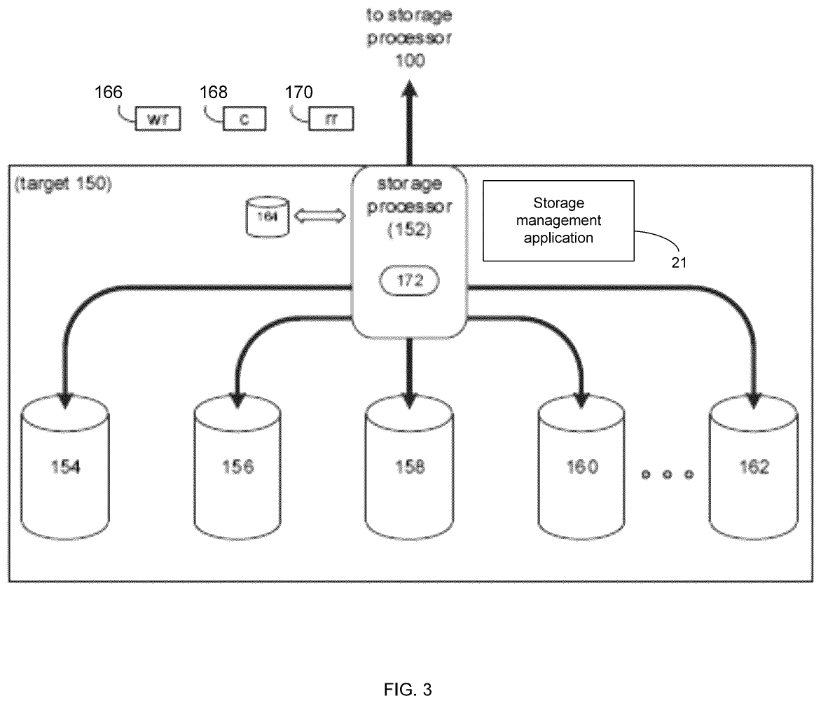

Referring also to the example implementation of FIGS. 2-3 (e.g., where computer 12 may be configured as a data storage system), computer 12 may include storage processor 100 and a plurality of storage targets (e.g., storage targets 102, 104, 106, 108, 110). In some implementations, storage targets 102, 104, 106, 108, 110 may include any of the above-noted storage devices. In some implementations, storage targets 102, 104, 106, 108, 110 may be configured to provide various levels of performance and/or high availability. For example, storage targets 102, 104, 106, 108, 110 may be configured to form a non-fully-duplicative fault-tolerant data storage system (such as a non-fully-duplicative RAID data storage system), examples of which may include but are not limited to: RAID 3 arrays, RAID 4 arrays, RAID 5 arrays, and/or RAID 6 arrays. It will be appreciated that various other types of RAID arrays may be used without departing from the scope of the present disclosure.

While in this particular example, computer 12 is shown to include five storage targets (e.g., storage targets 102, 104, 106, 108, 110), this is for example purposes only and is not intended limit the present disclosure. For instance, the actual number of storage targets may be increased or decreased depending upon, e.g., the level of redundancy/performance/capacity required.

Further, the storage targets (e.g., storage targets 102, 104, 106, 108, 110) included with computer 12 may be configured to form a plurality of discrete storage arrays. For instance, and assuming for example purposes only that computer 12 includes, e.g., ten discrete storage targets, a first five targets (of the ten storage targets) may be configured to form a first RAID array and a second five targets (of the ten storage targets) may be configured to form a second RAID array.

In some implementations, one or more of storage targets 102, 104, 106, 108, 110 may be configured to store coded data (e.g., via storage management process 21), wherein such coded data may allow for the regeneration of data lost/corrupted on one or more of storage targets 102, 104, 106, 108, 110. Examples of such coded data may include but is not limited to parity data and Reed-Solomon data. Such coded data may be distributed across all of storage targets 102, 104, 106, 108, 110 or may be stored within a specific storage target.

Examples of storage targets 102, 104, 106, 108, 110 may include one or more data arrays, wherein a combination of storage targets 102, 104, 106, 108, 110 (and any processing/control systems associated with storage management application 21) may form data array 112.

The manner in which computer 12 is implemented may vary depending upon e.g., the level of redundancy/performance/capacity required. For example, computer 12 may be configured as a SAN (i.e., a Storage Area Network), in which storage processor 100 may be, e.g., a dedicated computing system and each of storage targets 102, 104, 106, 108, 110 may be a RAID device. An example of storage processor 100 may include but is not limited to a VPLEX™, VNX™, PowerStore™, or Unity IM system offered by Dell EMC™ of Hopkinton, MA.

In the example where computer 12 is configured as a SAN, the various components of computer 12 (e.g., storage processor 100, and storage targets 102, 104, 106, 108, 110) may be coupled using network infrastructure 114, examples of which may include but are not limited to an Ethernet (e.g., Layer 2 or Layer 3) network, a fiber channel network, an InfiniBand network, or any other circuit switched/packet switched network.

As discussed above, various I/O requests (e.g., I/O request 15) may be generated. For example, these I/O requests may be sent from, e.g., client applications 22, 24, 26, 28 to, e.g., computer 12. Additionally/alternatively (e.g., when storage processor 100 is configured as an application server or otherwise), these I/O requests may be internally generated within storage processor 100 (e.g., via storage management process 21). Examples of I/O request 15 may include but are not limited to data write request 116 (e.g., a request that content 118 be written to computer 12) and data read request 120 (e.g., a request that content 118 be read from computer 12).

In some implementations, during operation of storage processor 100, content 118 to be written to computer 12 may be received and/or processed by storage processor 100 (e.g., via storage management process 21). Additionally/alternatively (e.g., when storage processor 100 is configured as an application server or otherwise), content 118 to be written to computer 12 may be internally generated by storage processor 100 (e.g., via storage management process 21).

As discussed above, the instruction sets and subroutines of storage management application 21, which may be stored on storage device 16 included within computer 12, may be executed by one or more processors and one or more memory architectures included with computer 12. Accordingly, in addition to being executed on storage processor 100, some or all of the instruction sets and subroutines of storage management application 21 (and/or optimization process 10) may be executed by one or more processors and one or more memory architectures included with data array 112.

In some implementations, storage processor 100 may include front end cache memory system 122. Examples of front end cache memory system 122 may include but are not limited to a volatile, solid-state, cache memory system (e.g., a dynamic RAM cache memory system), a non-volatile, solid-state, cache memory system (e.g., a flash-based, cache memory system), and/or any of the above-noted storage devices.

In some implementations, storage processor 100 may initially store content 118 within front end cache memory system 122. Depending upon the manner in which front end cache memory system 122 is configured, storage processor 100 (e.g., via storage management process 21) may immediately write content 118 to data array 112 (e.g., if front end cache memory system 122 is configured as a write-through cache) or may subsequently write content 118 to data array 112 (e.g., if front end cache memory system 122 is configured as a write-back cache).

In some implementations, one or more of storage targets 102, 104, 106, 108, 110 may include a backend cache memory system. Examples of the backend cache memory system may include but are not limited to a volatile, solid-state, cache memory system (e.g., a dynamic RAM cache memory system), a non-volatile, solid-state, cache memory system (e.g., a flash-based, cache memory system), and/or any of the above-noted storage devices.

### Storage Targets:

As discussed above, one or more of storage targets 102, 104, 106, 108, 110 may be a RAID device. For instance, and referring also to FIG. 3, there is shown example target 150, wherein target 150 may be one example implementation of a RAID implementation of, e.g., storage target 102, storage target 104, storage target 106, storage target 108, and/or storage target 110. An example of target 150 may include but is not limited to a VPLEX™, VNX™, PowerStore™, or Unity™ system offered by Dell EMC™ of Hopkinton, MA. Examples of storage devices 154, 156, 158, 160, 162 may include one or more electro-mechanical hard disk drives, one or more solid-state/flash devices, and/or any of the above-noted storage devices. It will be appreciated that while the term “disk” or “drive” may be used throughout, these may refer to and be used interchangeably with any types of appropriate storage devices as the context and functionality of the storage device permits.

In some implementations, target 150 may include storage processor 152 and a plurality of storage devices (e.g., storage devices 154, 156, 158, 160, 162). Storage devices 154, 156, 158, 160, 162 may be configured to provide various levels of performance and/or high availability (e.g., via storage management process 21). For example, one or more of storage devices 154, 156, 158, 160, 162 (or any of the above-noted storage devices) may be configured as a RAID 0 array, in which data is striped across storage devices. By striping data across a plurality of storage devices, improved performance may be realized. However, RAID 0 arrays may not provide a level of high availability. Accordingly, one or more of storage devices 154, 156, 158, 160, 162 (or any of the above-noted storage devices) may be configured as a RAID 1 array, in which data is mirrored between storage devices. By mirroring data between storage devices, a level of high availability may be achieved as multiple copies of the data may be stored within storage devices 154, 156, 158, 160, 162.

While storage devices 154, 156, 158, 160, 162 are discussed above as being configured in a RAID 0 or RAID 1 array, this is for example purposes only and not intended to limit the present disclosure, as other configurations are possible. For example, storage devices 154, 156, 158, 160, 162 may be configured as a RAID 3, RAID 4, RAID 5 or RAID 6 array.

While in this particular example, target 150 is shown to include five storage devices (e.g., storage devices 154, 156, 158, 160, 162), this is for example purposes only and not intended to limit the present disclosure. For instance, the actual number of storage devices may be increased or decreased depending upon, e.g., the level of redundancy/performance/capacity required.

In some implementations, one or more of storage devices 154, 156, 158, 160, 162 may be configured to store (e.g., via storage management process 21) coded data, wherein such coded data may allow for the regeneration of data lost/corrupted on one or more of storage devices 154, 156, 158, 160, 162. Examples of such coded data may include but are not limited to parity data and Reed-Solomon data. Such coded data may be distributed across all of storage devices 154, 156, 158, 160, 162 or may be stored within a specific storage device.

The manner in which target 150 is implemented may vary depending upon e.g., the level of redundancy/performance/capacity required. For example, target 150 may be a RAID device in which storage processor 152 is a RAID controller card and storage devices 154, 156, 158, 160, 162 are individual “hot-swappable” hard disk drives. Another example of target 150 may be a RAID system, examples of which may include but are not limited to an NAS (i.e., Network Attached Storage) device or a SAN (i.e., Storage Area Network).

In some implementations, storage target 150 may execute all or a portion of storage management application 21. The instruction sets and subroutines of storage management application 21, which may be stored on a storage device (e.g., storage device 164) coupled to storage processor 152, may be executed by one or more processors and one or more memory architectures included with storage processor 152. Storage device 164 may include but is not limited to any of the above-noted storage devices.

As discussed above, computer 12 may be configured as a SAN, wherein storage processor 100 may be a dedicated computing system and each of storage targets 102, 104, 106, 108, 110 may be a RAID device. Accordingly, when storage processor 100 processes data requests 116, 120, storage processor 100 (e.g., via storage management process 21) may provide the appropriate requests/content (e.g., write request 166, content 168 and read request 170) to, e.g., storage target 150 (which is representative of storage targets 102, 104, 106, 108 and/or 110).

In some implementations, during operation of storage processor 152, content 168 to be written to target 150 may be processed by storage processor 152 (e.g., via storage management process 21). Storage processor 152 may include cache memory system 172. Examples of cache memory system 172 may include but are not limited to a volatile, solid-state, cache memory system (e.g., a dynamic RAM cache memory system) and/or a non-volatile, solid-state, cache memory system (e.g., a flash-based, cache memory system). During operation of storage processor 152, content 168 to be written to target 150 may be received by storage processor 152 (e.g., via storage management process 21) and initially stored (e.g., via storage management process 21) within front end cache memory system 172.

Generally, in a metro replication or synchronization (sync) replication, there are two data centers or sites (e.g., SiteA and SiteB) and the computing, networking, and storage resources on the two sites provide the needed redundancy for the user's application. Applications that need higher availability typically configure the volumes in use by the application for metro sync or sync replication.

When a customer deploys applications, they deploy changes to applications after thorough testing. They do not test the new changes such as a new database table or changes in query processing or new webservers on the production data that is being served from storage appliances. They instead tend to create clones of the volumes used in production, perform any tests on the clones and then after a brief offline process, refresh the production volume from the clone.

A metro volume may be deployed for applications. As known in the art, “metro” is a term of art, which is also known as “Active-Active” or “Active-Cluster” with virtual volume based virtual machines stored on different appliances in a cluster, where updates on one volume is mirrored on the other volume. For instance, with volumes, LUNs or vVols being capable of being accessed from a host from any of the two storage appliances in two different clusters. Volumes deployed in a metro solution may have the same SCSI or NVMe identity, allowing the host to be able to direct I/O operations to the volume hosted on either of the two appliances. In PowerStore, these metro volumes are called “Stretched Volumes,” but they may also be known as, e.g., “MetroSync” or “Metro volumes.” When a metro volume is deployed for an application, each volume might have similar requirements. There are two example scenarios:
(1) Customer or user is interested in creating a normal clone for a metro volume on just one site of their choice (e.g., SiteA or SiteB). A metro or sync replication usually needs more resources, impacts the storage appliances more, and impacts host latency. Hence for some Test-Dev scenarios, customers might want to create a clone on just one side. There are facilities to do this.
(2) The customer or user is interested in deploying a metro clone like the metro volume and deploys their applications in the same manner that they are doing the production metro volume. For this scenario in specifically, the current process for the metro clone may involve the following example steps:
(a) Take a snapshot of the metro volume on SiteA.
(b) Create a clone from the snapshot.
(c) Stretch the clone to SiteB, just like stretching a volume. The change as compared to creating metro volume is that the clone is created from the snapshot.
(d) The metro clone resynchronizes the data between SiteA and SiteB and the metro clone is available for use once the resynchronization is complete.

This is not optimal because of the need to resync the data. Resynchronizing any data, no matter how small, is not needed. Therefore, as will be discussed below, the present disclosure may provide an optimized solution. Notably, the current process has similar resynchronization of the metro clone after a clone refresh, and this operation may be simplified as well using the teachings of the present disclosure.

### The Optimization Process:

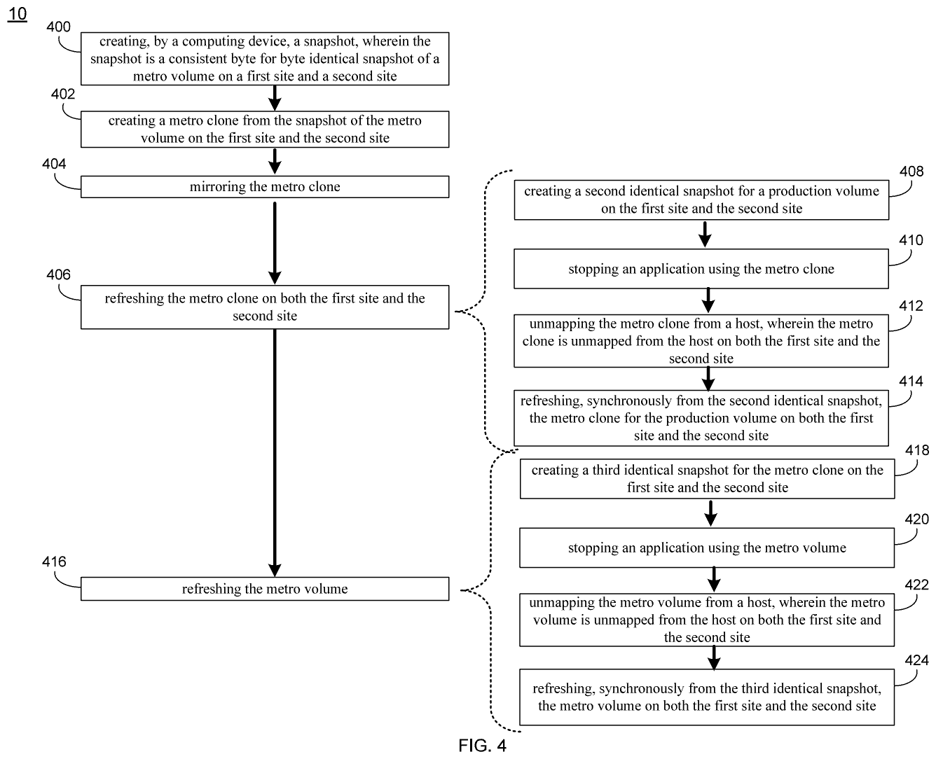

As discussed above and referring also at least to the example implementations of FIG. 4, optimization process (OP) 10 may create 400, by a computing device, a snapshot, wherein the snapshot may be a consistent byte for byte identical snapshot of a metro volume on a first site and a second site. OP 10 may create 402 a metro clone from the snapshot of the metro volume on the first site and the second site. OP 10 may mirror 404 the metro clone. OP 10 may refresh 406 the metro clone on both the first site and the second site.

For example, regarding metro clone creation, in some implementations, a customer may have a choice to create a simple clone (e.g., on one site) or a stretched in-sync clone of a metro volume with sync replication or metro sync setup for the metro clone. This is a composite operation as outlined in the 3 steps below.

In some implementations, OP 10 may create 400, by a computing device, a snapshot, wherein the snapshot may be a consistent byte for byte identical snapshot of a metro volume on a first site and a second site. For instance, OP 10 may create 10 a consistent byte for byte identical snapshot on both SiteA and SiteB. Identical snapshots for a stretched volume may be created in multiple ways. For example, in its simplest form, writes may be quiesced to a volume to prevent new host writes, wait for any in-progress writes on both appliances to complete and issue a snapshot operation locally and on the remote appliance.

In some implementations, OP 10 may create 402 a metro clone from the snapshot of the metro volume on the first site and the second site. For example, OP 10 may create 402 a metro clone from the identical snapshot. From orchestration purposes, when compared to creating a metro volume, the metro clone may be created from an existing identical snapshot on SiteA and SiteB. In some implementations, OP 10 may mirror 404 the metro clone. For example, OP 10 may setup mirror(s) for the metro clone.

For example, regarding metro clone refresh, in some implementations, OP 10 may refresh 406 the metro clone on both the first site and the second site. For example, in a Test-Dev environment where clones get used frequently, the lifecycle of the clone may involve a refresh from a newer snapshot. The example use-case is for the test team to have the latest copy of the production volume for any future testing. Similar use-cases exist for an application using a metro volume and metro clone. When a clone is refreshed, it may be necessary and good practice to unmap the clone from any application using it. This may ensure that any stale data is not flushed from the host to the clone after the clone is refreshed.

For instance, assume for example purposes only that a customer has a requirement to refresh a metro clone at a specific point in time. In some implementations, refreshing 406 the metro clone on both the first site and the second site may include creating 408 a second identical snapshot for a production volume on the first site and the second site. For instance, an identical snapshot may be created 408 for the production volume on SiteA and SiteB. In some implementations, refreshing 406 the metro clone on both the first site and the second site may further include stopping 410 an application using the metro clone, and in some implementations, refreshing 406 the metro clone on both the first site and the second site may further include unmapping 412 the metro clone from a host, wherein the metro clone may be unmapped from the host on both the first site and the second site. For instance, the application using the metro clone may be stopped 410 and the clone may be unmapped 412 from the host(s). In some implementations, the metro clone needs to be unmapped from hosts on both sites (e.g., SiteA and SiteB).

In some implementations, refreshing 406 the metro clone on both the first site and the second site may further include refreshing 414, synchronously from the second identical snapshot, the metro clone for the production volume on both the first site and the second site. For instance, the metro clone may be refreshed 414 from the identical snapshot in a synchronized fashion on both SiteA and SiteB. As a result of the above steps, the metro clone is now ready to use.

In some implementations, OP 10 may refresh 416 the metro volume. For instance, a very similar sequence of steps may be used to refresh the metro volume from the metro clone if required. For example, assume that the customer has a use-case to refresh a metro volume from the metro clone, which has just been tested. In the example, and in some implementations, refreshing 416 the metro volume may include creating 418 a third identical snapshot for the metro clone on the first site and the second site, stopping 420 an application using the metro volume, unmapping 422 the metro volume from a host, wherein the metro volume may be unmapped from the host on both the first site and the second site, and refreshing 424, synchronously from the third identical snapshot, the metro volume on both the first site and the second site. For instance, an identical snapshot may be created 418 for the metro clone on SiteA and SiteB. The application using the metro volume may be stopped 420 and the volume may be unmapped 422 from host(s). In some implementations, the metro volume needs to be unmapped from hosts on both sites (e.g., SiteA and SiteB). The metro volume may be refreshed 416/424 from the identical snapshot in a synchronized fashion on both SiteA and SiteB. As a result of the above steps, the refreshed metro volume is ready to use.

Advantageously, the ability of OP 10 to leverage identical snapshot(s) on SiteA and SiteB of metro replication or sync replication to create a clone avoids the overhead of resynchronizing the clone between the two sites, and it may provide the customer with an instantaneous metro clone, refresh of a metro clone, and refresh of a metro volume.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. As used herein, the language “at least one of A, B, and C” (and the like) should be interpreted as covering only A, only B, only C, or any combination of the three, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents (e.g., of all means or step plus function elements) that may be in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, substitutions, and any combinations thereof will be apparent to those of ordinary skill in the art without departing from the scope and spirit of the disclosure. The implementation(s) were chosen and described in order to explain the principles of the disclosure and the practical application, and to enable others of ordinary skill in the art to understand the disclosure for various implementation(s) with various modifications and/or any combinations of implementation(s) as are suited to the particular use contemplated.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

1. A computer-implemented method comprising:
creating, by a computing device, a snapshot, wherein the snapshot is a consistent byte for byte identical snapshot of a metro volume on both a first site and a second site;
creating a metro clone from the identical snapshot of the metro volume on the first site and the second site;
mirroring the metro clone; and
refreshing the metro clone on both the first site and the second site.

2. The computer-implemented method of claim 1 wherein refreshing the metro clone on both the first site and the second site includes creating a second identical snapshot for a production volume on the first site and the second site.

3. The computer-implemented method of claim 2 wherein refreshing the metro clone on both the first site and the second site further includes stopping an application using the metro clone.

4. The computer-implemented method of claim 3 wherein refreshing the metro clone on both the first site and the second site further includes unmapping the metro clone from a host, wherein the metro clone is unmapped from the host on both the first site and the second site.

5. The computer-implemented method of claim 4 wherein refreshing the metro clone on both the first site and the second site further includes refreshing, synchronously from the second identical snapshot, the metro clone for the production volume on both the first site and the second site.

6. The computer-implemented method of claim 1 further comprising refreshing the metro volume.

7. The computer-implemented method of claim 6 wherein refreshing the metro volume includes:
creating a third identical snapshot for the metro clone on the first site and the second site;
stopping an application using the metro volume;
unmapping the metro volume from a host, wherein the metro volume is unmapped from the host on both the first site and the second site; and
refreshing, synchronously from the third identical snapshot, the metro volume on both the first site and the second site.

8. A computer program product residing on a computer readable storage medium having a plurality of instructions stored thereon which, when executed across one or more processors, causes at least a portion of the one or more processors to perform operations comprising:
creating, by a computing device, a snapshot, wherein the snapshot is a consistent byte for byte identical snapshot of a metro volume on both a first site and a second site;
creating a metro clone from the identical snapshot of the metro volume on the first site and the second site;
mirroring the metro clone; and
refreshing the metro clone on both the first site and the second site.

9. The computer program product of claim 8 wherein refreshing the metro clone on both the first site and the second site includes creating a second identical snapshot for a production volume on the first site and the second site.

10. The computer program product of claim 9 wherein refreshing the metro clone on both the first site and the second site further includes stopping an application using the metro clone.

11. The computer program product of claim 10 wherein refreshing the metro clone on both the first site and the second site further includes unmapping the metro clone from a host, wherein the metro clone is unmapped from the host on both the first site and the second site.

12. The computer program product of claim 11 wherein refreshing the metro clone on both the first site and the second site further includes refreshing, synchronously from the second identical snapshot, the metro clone for the production volume on both the first site and the second site.

13. The computer program product of claim 8 wherein the operations further comprise refreshing the metro volume.

14. The computer program product of claim 13 wherein refreshing the metro volume includes:
creating a third identical snapshot for the metro clone on the first site and the second site;
stopping an application using the metro volume;
unmapping the metro volume from a host, wherein the metro volume is unmapped from the host on both the first site and the second site; and
refreshing, synchronously from the third identical snapshot, the metro volume on both the first site and the second site.

15. A computing system including one or more processors and one or more memories configured to perform operations comprising:
creating, by a computing device, a snapshot, wherein the snapshot is a consistent byte for byte identical snapshot of a metro volume on both a first site and a second site;
creating a metro clone from the identical snapshot of the metro volume on the first site and the second site;
mirroring the metro clone; and
refreshing the metro clone on both the first site and the second site.

16. The computing system of claim 15 wherein refreshing the metro clone on both the first site and the second site includes creating a second identical snapshot for a production volume on the first site and the second site.

17. The computing system of claim 16 wherein refreshing the metro clone on both the first site and the second site further includes:
stopping an application using the metro clone; and
unmapping the metro clone from a host, wherein the metro clone is unmapped from the host on both the first site and the second site.

18. The computing system of claim 17 wherein refreshing the metro clone on both the first site and the second site further includes refreshing, synchronously from the second identical snapshot, the metro clone for the production volume on both the first site and the second site.

19. The computing system of claim 15 wherein the operations further comprise refreshing the metro volume.

20. The computing system of claim 19 wherein refreshing the metro volume includes:
creating a third identical snapshot for the metro clone on the first site and the second site;
stopping an application using the metro volume;
unmapping the metro volume from a host, wherein the metro volume is unmapped from the host on both the first site and the second site; and
refreshing, synchronously from the third identical snapshot, the metro volume on both the first site and the second site.
